(19) United States
(12) Patent Application Publication
(10) Pub. No.: US 2024/0430168 A1
(43) Pub. Date: Dec. 26, 2024

(54) METHOD AND APPARATUS FOR TRAFFIC PROBING

(71) Applicant: Telefonaktiebolaget LM Ericsson (publ), Stockholm (SE)

(72) Inventors: Yunjie LU, Shanghai (CN); Helen ÖRTENBLAD, Göteborg (SE); Deqin ZHAN, Shanghai (CN); Wu WANG, Shanghai (CN); Abhishek JAISWAL, Göteborg (SE); Yiming WU, Shanghai (CN)

(21) Appl. No.: 18/690,419

(22) PCT Filed: Sep. 8, 2022
(86) PCT No.: PCT/CN2022/117811

§ 371 Date: Mar. 8, 2024

(30) Foreign Application Priority Data
Sep. 9, 2021 (WO) PCT/CN2021/117483

(51) Int. Cl. H04L 41/12; H04L 67/02

(52) U.S. Cl. CPC H04L 41/12; H04L 67/02

(57) ABSTRACT

Embodiments of the present disclosure provide method and apparatus for traffic probing. A method performed by a sender network function (NF) includes sending a first message to a receiver NF. The first message comprises a new HTTP header which comprises an NF instance identifier (ID) of the sender NF and an NF instance ID of the receiver NF.

### TECHNICAL FIELD

The non-limiting and exemplary embodiments of the present disclosure generally relate to the technical field of communications, and specifically to methods and apparatuses for traffic probing.

### BACKGROUND

This section introduces aspects that may facilitate a better understanding of the disclosure. Accordingly, the statements of this section are to be read in this light and are not to be understood as admissions about what is in the prior art or what is not in the prior art.

In communication networks for example NR (new radio) as defined by 3rd Generation Partnership Project (3GPP), it has introduced Service Based Architecture (SBA) where network entities are specified as Network Functions (NFs) providing/consuming services. NF service producer and NF service consumer communicate with each other via Service Based Interface (SBI) implemented with Hyper Text Transfer Protocol (HTTP) protocol.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

According to clause 7.1.2 of 3GPP TS 23.501 V17.1.1, the disclosure of which is incorporated by reference herein in its entirety, the end-to-end interaction between two Network Functions (Consumer and Producer) within an NF service framework follows two mechanisms, irrespective of whether Direct Communication or Indirect Communication is used: “Request-response” and “Subscribe-Notify”.

FIG. 1 shows an example of “Request-response” mechanism according to an embodiment of the present disclosure. A Control Plane NF_B (NF Service Producer) is requested by another Control Plane NF_A (NF Service Consumer) to provide a certain NF service, which either performs an action or provides information or both. NF_B provides an NF service based on the request by NF_A. In order to fulfill the request, NF_B may in turn consume NF services from other NFs. In Request-response mechanism, communication is one to one between two NFs (consumer and producer) and a one-time response from the producer to a request from the consumer is expected within a certain timeframe. The NF Service Producer may also add a Binding Indication (see clause 6.3.1.0 of 3GPP TS 23.501 V17.1.1) in the Response, which may be used by the NF Service Consumer to select suitable NF service producer instance(s) for subsequent requests. For indirect communication, the NF Service Consumer copies the Binding Indication into the Routing Binding indication, that is included in subsequent requests, to be used by the SCP to discover a suitable NF service producer instance(s).

FIG. 2 shows an example of “Subscribe-Notify” mechanism according to an embodiment of the present disclosure. A Control Plane NF_A (NF Service Consumer) subscribes to NF Service offered by another Control Plane NF_B (NF Service Producer). Multiple Control Plane NFs may subscribe to the same Control Plane NF Service. NF B notifies the results of this NF service to the interested NF(s) that subscribed to this NF service. The subscription request shall include the notification endpoint, i.e. Notification Target Address) and a Notification Correlation ID (e.g. the notification URL (Uniform Resource Locator)) of the NF Service Consumer to which the event notification from the NF Service Producer should be sent to.

The notification endpoint URL can contain both the notification endpoint and the Notification Correlation ID.

The NF Service Consumer may add a Binding Indication (see clause 6.3.1.0 of 3GPP TS 23.501 V17.1.1) in the subscribe request, which may be used by the NF Service Producer to discover a suitable notification endpoint. For indirect communication, the NF Service Producer copies the Binding Indication into the Routing Binding Indication, that is included in the response, to be used by the SCP to discover a suitable notification target. The NF Service Producer may also add a Binding Indication (see clause 6.3.1.0 of 3GPP TS 23.501 V17.1.1) in the subscribe response, which may be used by the NF Service Consumer (or SCP (service communication proxy)) to select suitable NF service producer instance(s) or NF producer service instance. In addition, the subscription request may include notification request for periodic updates or notification triggered through certain events (e.g. the information requested gets changed, reaches certain threshold etc.). The subscription for notification can be done through one of the following ways:
Explicit subscription: A separate request/response exchange between the NF Service Consumer and the NF Service Producer; or
Implicit subscription: The subscription for notification is included as part of another NF service operation of the same NF Service; or
Default notification endpoint: Registration of a notification endpoint for each type of notification the NF consumer is interested to receive, as an NF service parameter with the NRF during the NF and NF service Registration procedure as specified in clause 4.17.1 of 3GPP TS 23.502 V17.1.0, the disclosure of which is incorporated by reference herein in its entirety.

The NF Service Consumer may also add a Binding Indication (see clause 6.3.1.0 of 3GPP TS 23.501 V17.1.1) in the response to the notification request, which may be used by the NF Service Producer to discover a suitable notification endpoint. For indirect communication, the NF Service Producer copies the Binding Indication into the Routing Binding indication that is included in subsequent notification requests. The binding indication is then used by the SCP to discover a suitable notification target.

FIG. 3 shows an example of “Subscribe-Notify” mechanism according to another embodiment of the present disclosure. A Control Plane NF_A may also subscribe to NF Service offered by Control Plane NF_B on behalf of Control Plane NF_C, i.e. it requests the NF Service Producer to send the event notification to another consumer(s). In this case, NF_A includes the notification endpoint, i.e. Notification Target Address) and a Notification Correlation ID, of the NF_C in the subscription request. NF_A may also additionally include the notification endpoint and a Notification Correlation ID of NF A associated with subscription change related Event ID(s), e.g. Subscription Correlation ID Change, in the subscription request, so that NF_A can receive the notification of the subscription change related event. The NF_A may add Binding Indication (see clause 6.3.1.0) in the subscribe request.

Routing of the messages for the NF interaction mechanisms above may be direct, as shown in the FIGS. 1-3, or indirect. In the case of Indirect Communication, an SCP is employed by the NF service consumer. The SCP routes messages between NF service consumers and NF service producers based on the Routing Binding Indication if available, and may do discovery and associated selection of the NF service producer on behalf of an NF service consumer. FIG. 4 shows a principle for a request-response interaction using Indirect Communication according to an embodiment of the present disclosure. FIG. 5 shows an example of a subscribe-notify interaction using Indirect Communication according to an embodiment of the present disclosure. The subscribe request and notify request can be routed by different SCPs.

In real network deployments, there are requirement to monitor traffic between certain network entities, e.g., to filter the traffics between two specified network entities and/or apply extra business logics like troubleshooting, performance measurement, etc.

In legacy networks, the communications model between network entities mainly based on bi-directional connection. Traffic probe can be applied with the address information of the two ends of the connection, e.g., IP addresses and port numbers of two ends of a TCP (Transmission Control Protocol)/UDP (User Datagram Protocol) connections, or the originator and terminator of the diameter path.

In 5GC (in 5G (fifth generation) Core Network) Service Based Architecture, the traffic probe with address information cannot be used due to some reasons.

As a first example, HTTP is one direction connection with request/response traffic model. Communication between two NFs usually uses multiple HTTP connections with HTTP client/server pairs. E.g., on N11 interface, access and mobility function (AMF) invokes SMF (Session Management Function) PDU (Protocol Data Unit) session service where SMF act as HTTP server (AMF create HTTP connection towards SMF) and at the same time SMF invoke AMF Communication services (SMF create HTTP connection towards the AMF).

As a second example, one NF may consume multiple services on another NF, which are exposed on different service access points with different IP (Internet protocol) address/port numbers. e.g., SMF invokes AMF Communication Service, Event Exposure Service as well as Mobile Terminating service.

As a third example, for redundancy, message prioritization, even for the same service, multiple HTTP connections will be established between two NFs to transport normal traffics. Furthermore, for HTTP/2 stream ID (identifier) exhaustion issue, new HTTP connection may be created at any time to replace old HTTP connection.

To overcome or mitigate at least one of above mentioned problems or other problems, a new solution for traffic probing is needed for example in 5GC with Service Based Architecture.

In an embodiment, as required for Network Function registration and discovery, each NF in 5GC holds a globally unique NF instance identifier. To uniquely identifier an NF pair for traffic probing, the NF instance identifier of the two NFs could be the most suitable information. To enable the traffic probing, it requires that the source NF instance ID and the target NF instance ID are carried in a service message over SBI.

In a first embodiment, the source NF instance ID and/or the target NF instance ID may be carried in a message body.

In a second embodiment, the source NF instance ID and/or the target NF instance ID may be carried in an existing HTTP header required by SBI protocols.

In a third embodiment, the source NF instance ID and/or the target NF instance ID may be carried in a new HTTP header, which may be less impact to existing protocol definition (compare to the second embodiment) and more efficient for traffic filtering (compare to the first embodiment).

In a first aspect of the disclosure, there is provided a method performed by a sender network function (NF). The method comprises sending a first message to a receiver NF. The first message comprises a new Hyper Text Transfer Protocol (HTTP) header which comprises an NF instance identifier (ID) of the sender NF and an NF instance ID of the receiver NF.

In an embodiment, the NF instance ID of the sender NF and the NF instance ID of the receiver NF are used to identify a message exchanged between the sender NF and the receiver NF.

In an embodiment, the new HTTP header further comprises an NF service instance ID of the sender NF and an NF service instance ID of the receiver NF.

In an embodiment, the NF instance ID of the sender NF, the NF instance ID of the receiver NF, the NF service instance ID of the sender NF and the NF service instance ID of the receiver NF are used to identify a message exchanged between the sender NF and the receiver NF.

In an embodiment, the first message is a service request message or a notification request message.

In an embodiment, the method further comprises receiving a second message from the receiver NF. The second message comprises the NF instance ID of the sender NF and the NF instance ID of the receiver NF.

In an embodiment, the second message further comprises the NF service instance ID of the sender NF and the NF service instance ID of the receiver NF.

In an embodiment, the second message is an HTTP message.

In an embodiment, the second message is a service response message or a notification response message.

In an embodiment, the sender NF is an NF service consumer or an NF service producer.

In an embodiment, the receiver NF is an NF service producer or an NF service consumer.

In an embodiment, the sender NF is an HTTP client and the receiver NF is an HTTP server.

In an embodiment, the first message and second message further comprise an NF set ID of the sender NF and an NF set ID of the receiver NF.

In a second aspect of the disclosure, there is provided a method performed by a receiver network function (NF). The method comprises receiving a first message from a sender NF. The first message comprises a new HTTP header which comprises an NF instance identifier (ID) of the sender NF and an NF instance ID of the receiver NF.

In an embodiment, the NF instance ID of the sender NF and the NF instance ID of the receiver NF are used to identify a message exchanged between the sender NF and the receiver NF.

In an embodiment, the new HTTP header further comprises an NF service instance ID of the sender NF and an NF service instance ID of the receiver NF.

In an embodiment, the NF instance ID of the sender NF, the NF instance ID of the receiver NF, the NF service instance ID of the sender NF and the NF service instance ID of the receiver NF are used to identify a message exchanged between the sender NF and the receiver NF.

In an embodiment, the first message is a service request message or a notification request message.

In an embodiment, the method further comprises sending a second message to the sender NF, wherein the second message comprises the NF instance ID of the sender NF and the NF instance ID of the receiver NF.

In an embodiment, the second message further comprises the NF service instance ID of the sender NF and the NF service instance ID of the receiver NF.

In an embodiment, the second message is an HTTP message.

In an embodiment, the second message is a service response message or a notification response message.

In an embodiment, the sender NF is an NF service consumer or an NF service producer.

In an embodiment, the receiver NF is an NF service producer or an NF service consumer.

In an embodiment, the sender NF is an HTTP client and the receiver NF is an HTTP server.

In an embodiment, the first message and second message further comprise an NF set ID of the sender NF and an NF set ID of the receiver NF.

In a third aspect of the disclosure, there is provided a method performed by a service communication proxy (SCP). The method comprises receiving a third message from a sender network function (NF) or a receiver NF. The third message comprises a new HTTP header which comprises an NF instance ID of the sender NF and an NF instance ID of the receiver NF. The method further comprises sending a fourth message to the receiver NF or the sender NF. The fourth message comprises the new HTTP header which comprises the NF instance ID of the sender NF and the NF instance ID of the receiver NF.

In an embodiment, the NF instance ID of the sender NF and the NF instance ID of the receiver NF are used to identify a message exchanged between the sender NF and the receiver NF.

In an embodiment, the new HTTP header further comprises an NF service instance ID of the sender NF and an NF service instance ID of the receiver NF.

In an embodiment, the NF instance ID of the sender NF, the NF instance ID of the receiver NF, the NF service instance ID of the sender NF and the NF service instance ID of the receiver NF are used to identify a message exchanged between the sender NF and the receiver NF.

In an embodiment, the third message and the fourth message comprise at least one of a service request message, a notification request message, a service response message, or a notification response message.

In an embodiment, the sender NF is an NF service consumer or an NF service producer.

In an embodiment, the receiver NF is NF service consumer or an NF service producer.

In an embodiment, the sender NF is an HTTP client and the receiver NF is an HTTP server.

In an embodiment, the third message and the fourth message further comprise an NF set ID of the sender NF and an NF set ID of the receiver NF.

In a fourth aspect of the disclosure, there is provided a method performed by a network entity (NE). The method comprises sending or receiving a message exchanged between a sender NF and a receiver NF. The message comprises a new HTTP header which comprises an NF instance identifier (ID) of the sender NF and an NF instance ID of the receiver NF. The method further comprises identifying the message exchanged between the sender NF and the receiver NF based on the NF instance ID of the sender NF and the NF instance ID of the receiver NF.

In an embodiment, the new HTTP header further comprises an NF service instance ID of the sender NF and an NF service instance ID of the receiver NF.

In an embodiment, the message exchanged between the sender NF and the receiver NF is identified further based on the NF service instance ID of the sender NF and the NF service instance ID of the receiver NF.

In an embodiment, the message is an HTTP message.

In an embodiment, the message is a service request message or a notification request message or a service response message or a notification response message.

In an embodiment, the sender NF is an HTTP client and the receiver NF is an HTTP server.

In an embodiment, the message further comprises an NF set ID of the sender NF and an NF set ID of the receiver NF.

In an embodiment, the method further comprises performing an operation on the identified message.

In an embodiment, the operation comprises at least one of monitoring traffic, filtering traffic, applying policy, troubleshooting, or performance measurement.

In another aspect of the disclosure, there is provided a sender network function (NF). The sender NF comprises a processor and a memory coupled to the processor. Said memory contains instructions executable by said processor. Said sender NF is operative to send a first message to a receiver NF. The first message comprises a new Hyper Text Transfer Protocol (HTTP) header which comprises an NF instance identifier (ID) of the sender NF and an NF instance ID of the receiver NF.

In another aspect of the disclosure, there is provided a receiver network function (NF). The receiver NF comprises a processor and a memory coupled to the processor. Said memory contains instructions executable by said processor. Said receiver NF is operative to receive a first message from a sender NF. The first message comprises a new HTTP header which comprises an NF instance identifier (ID) of an sender NF and an NF instance ID of an receiver NF.

In another aspect of the disclosure, there is provided a service communication proxy (SCP). The SCP comprises a processor and a memory coupled to the processor. Said memory contains instructions executable by said processor. Said SCP is operative to receive a third message from a sender network function (NF) or a receiver NF. The third message comprises a new HTTP header which comprises an NF instance ID of the sender NF and an NF instance ID of the receiver NF. Said SCP is further operative to send a fourth message to the receiver NF or the sender NF. The fourth message comprises the new HTTP header which comprises the NF instance ID of the sender NF and the NF instance ID of the receiver NF.

In another aspect of the disclosure, there is provided a network entity (NE). The NE comprises a processor and a memory coupled to the processor. Said memory contains instructions executable by said processor. Said NE is operative to send or receive a message exchanged between a sender NF and a receiver NF. The message comprises a new HTTP header which comprises an NF instance identifier (ID) of the sender NF and an NF instance ID of the receiver NF. Said NE is further operative to identify the message exchanged between the sender NF and the receiver NF based on the NF instance ID of the sender NF and the NF instance ID of the receiver NF.

In another aspect of the disclosure, there is provided a sender NF. The sender NF comprises a sending module configured to send a first message to a receiver NF. The first message comprises a new HTTP header which comprises an NF instance identifier (ID) of the sender NF and an NF instance ID of the receiver NF.

In an embodiment, the sender NF further comprises a receiving module configured to receive a second message from the receiver NF. The second message comprises the NF instance ID of the sender NF and the NF instance ID of the receiver NF.

In another aspect of the disclosure, there is provided a receiver NF. The receiver NF comprises a receiving module configured to receive a first message from a sender NF. The first message comprises a new HTTP header which comprises an NF instance identifier (ID) of the sender NF and an NF instance ID of the receiver NF.

In an embodiment, the receiver NF further comprises a sending module configured to send a second message to the sender NF. The second message comprises the new HTTP header which comprises the NF instance ID of the sender NF and the NF instance ID of the receiver NF.

In another aspect of the disclosure, there is provided a SCP. The SCP comprises a receiving module configured to receive a third message from a sender network function (NF) or a receiver NF. The third message comprises a new HTTP header which comprises an NF instance ID of the sender NF and an NF instance ID of the receiver NF. The SCP further comprises a sending module configured to send a fourth message to the receiver NF or the sender NF. The fourth message comprises the new HTTP header which comprises the NF instance ID of the sender NF and the NF instance ID of the receiver NF.

In another aspect of the disclosure, there is provided a NE. The NE comprises a sending or receiving module configured to send or receive a message exchanged between a sender NF and a receiver NF. The message comprises a new HTTP header which comprises an NF instance identifier (ID) of the sender NF and an NF instance ID of the receiver NF. The NE further comprises an identifying module configured to identify the message exchanged between the sender NF and the receiver NF based on the NF instance ID of the sender NF and the NF instance ID of the receiver NF.

In an embodiment, the NE further comprises a performing module configured to perform an operation on the identified message.

In another aspect of the disclosure, there is provided a computer program product comprising instructions which when executed by at least one processor, cause the at least one processor to perform the method according to any one of the first, second, third, or fourth aspects.

In another aspect of the disclosure, there is provided a computer-readable storage medium storing instructions which when executed by at least one processor, cause the at least one processor to perform the method according to any one of the first, second, third, or fourth aspects.

Embodiments herein may provide many advantages, of which a non-exhaustive list of examples follows. In some embodiments herein, it is proposed a new mechanism to allow traffic probing between two specified network functions for example in 5GC Service Based Architecture. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 shows an example of “Request-response” mechanism according to an embodiment of the present disclosure;

FIG. 2 shows an example of “Subscribe-Notify” mechanism according to an embodiment of the present disclosure;

FIG. 3 shows an example of “Subscribe-Notify” mechanism according to another embodiment of the present disclosure;

FIG. 4 shows a principle for a request-response interaction using Indirect Communication according to an embodiment of the present disclosure;

FIG. 5 shows an example of a subscribe-notify interaction using Indirect Communication according to an embodiment of the present disclosure;

FIG. 6 schematically shows a roaming 5G system architecture according to an embodiment of the present disclosure;

FIG. 7 shows communication models for NF/NF services interaction according to an embodiment of the present disclosure;

FIG. 8 shows a flowchart of a method according to an embodiment of the present disclosure;

FIG. 9 shows a flowchart of a method according to another embodiment of the present disclosure;

FIG. 10 shows a flowchart of a method according to another embodiment of the present disclosure;

FIG. 11 shows a flowchart of a method according to another embodiment of the present disclosure;

FIG. 12 shows a flowchart of a method according to another embodiment of the present disclosure;

FIG. 13 shows a flowchart of a method according to another embodiment of the present disclosure;

FIG. 14 shows a flowchart of a method according to another embodiment of the present disclosure;

FIG. 15 shows a flowchart of a method according to another embodiment of the present disclosure;

FIG. 16 shows a flowchart of a method according to another embodiment of the present disclosure;

FIG. 17 shows a flowchart of a method according to another embodiment of the present disclosure;

FIG. 18a shows a flowchart of NF interaction mechanisms according to an embodiment of the present disclosure;

FIG. 18b is a block diagram showing an apparatus suitable for practicing some embodiments of the disclosure;

FIG. 19 is a block diagram showing a sender NF according to an embodiment of the disclosure;

FIG. 20 is a block diagram showing a receiver NF according to an embodiment of the disclosure;

FIG. 21 is a block diagram showing a SCP according to an embodiment of the disclosure;

FIG. 22 is a block diagram showing a sender NF according to another embodiment of the disclosure;

FIG. 23 is a block diagram showing a SCP according to another embodiment of the disclosure; and

FIG. 24 is a block diagram showing an NE according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G communication protocols, and/or any other protocols either currently known or to be developed in the future.

The term “network function” refers to any suitable network function (NF) which can be implemented in a network node (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE) may include MME (Mobile Management Entity), HSS (home subscriber server), Policy and Charging Rules Function (PCRF), Packet Data Network Gateway (PGW), PGW control plane (PGW-C), Serving gateway (SGW), SGW control plane (SGW-C), E-UTRAN Node B (eNB), etc. In other embodiments, the network function may comprise different types of NFs for example depending on a specific network.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

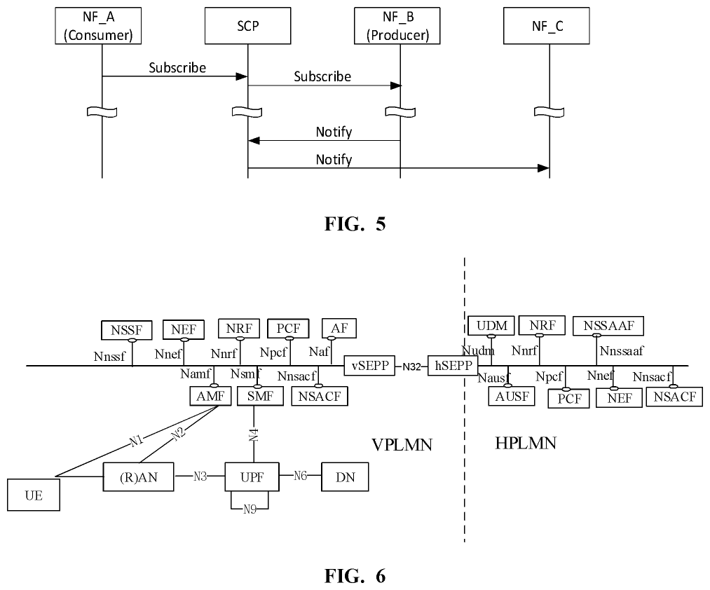

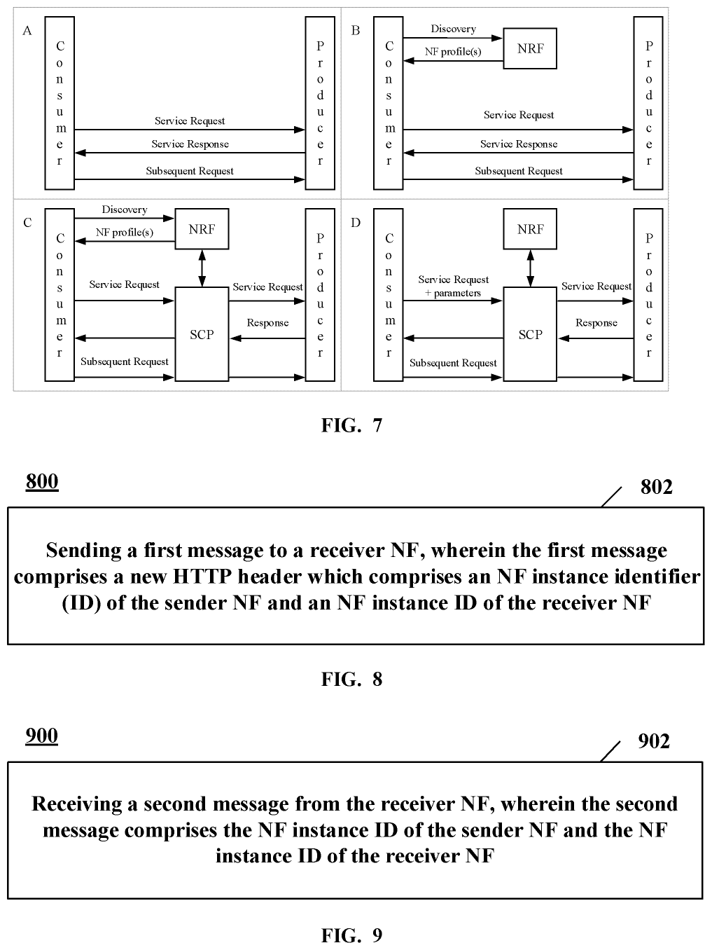

Although the subject matter described herein may be implemented in any appropriate type of system using any suitable components, the embodiments disclosed herein are described in relation to a communication system complied with the exemplary system architecture illustrated in FIGS. 6-7. For simplicity, the system architectures of FIG. 6-7 only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

FIG. 6 schematically shows a roaming 5G system architecture according to an embodiment of the present disclosure. The architecture of FIG. 6 is same as FIG. 4.2.4-1 as described in 3GPP TS 23.501 V17.1.1, the disclosure of which is incorporated by reference herein in its entirety. The system architecture of FIG. 6 may comprise some exemplary elements such as AUSF, AMF, DN (data network), NEF, NRF, NSSF, PCF, SMF, UDM, UPF, AF, UE, (R)AN, SCP (Service Communication Proxy), NSACF (Network Slice Admission Control Function), vSEPP (visited Security Edge Protection Proxy), hSEPP (home Security Edge Protection Proxy), etc.

In accordance with an exemplary embodiment, the UE can establish a signaling connection with the AMF over the reference point N1, as illustrated in FIG. 6. This signaling connection may enable NAS (Non-access stratum) signaling exchange between the UE and the core network, comprising a signaling connection between the UE and the (R)AN and the N2 connection for this UE between the (R)AN and the AMF. The (R)AN can communicate with the UPF over the reference point N3. The UE can establish a protocol data unit (PDU) session to the DN (data network, e.g. an operator network or Internet) through the UPF over the reference point N6.

As further illustrated in FIG. 6, the exemplary system architecture also contains the service-based interfaces such as Nnrf, Nnef, Nausf, Nudm, Npcf, Namf, Nnsacf and Nsmf exhibited by NFs such as the NRF, the NEF, the AUSF, the UDM, the PCF, the AMF, the NSACF and the SMF. In addition, FIG. 3 also shows some reference points such as N1, N2, N3, N4, N6, N32 and N9, which can support the interactions between NF services in the NFs. For example, these reference points may be realized through corresponding NF service-based interfaces and by specifying some NF service consumers and providers as well as their interactions in order to perform a particular system procedure.

Various NFs shown in FIG. 6 may be responsible for functions such as session management, mobility management, authentication, security, etc. The AUSF, AMF, DN, NEF, NRF, NSSF, PCF, SMF, UDM, UPF, AF, UE, (R)AN, SCP, NSACF may include the functionality for example as defined in clause 6.2 of 3GPP TS 23.501 V17.1.1.

FIG. 7 shows communication models for NF/NF services interaction according to an embodiment of the present disclosure. Table 1 summarizes the communication models, their usage and how they relate to the usage of an SCP.

TABLE 1
Communication models for NF/NF services interaction summary

| Communication | | |
|---|---|---|
| between | | Communi- |
| consumer and | Service discovery and | cation |
| producer | request routing | model |
| Direct | No NRF or SCP; direct routing | A |
| communication | Discovery using NRF services; | B |
| | no SCP; direct routing | |
| Indirect | Discovery using NRF services; | C |
| communication | selection for specific instance | |
| | from the Set can be delegated | |
| | to SCP. Routing via SCP | |
| | Discovery and associated selection | D |
| | delegated to an SCP using discovery | |
| | and selection parameters in service | |
| | request; routing via SCP | |

Model A—Direct communication without NRF interaction: Neither NRF nor SCP are used. Consumers are configured with producers' “NF profiles” and directly communicate with a producer of their choice.

Model B—Direct communication with NRF interaction: Consumers do discovery by querying the NRF. Based on the discovery result, the consumer does the selection. The consumer sends the request to the selected producer.

Model C—Indirect communication without delegated discovery: Consumers do discovery by querying the NRF. Based on discovery result, the consumer does the selection of an NF Set or a specific NF instance of NF set. The consumer sends the request to the SCP containing the address of the selected service producer pointing to an NF service instance or a set of NF service instances. In the latter case, the SCP selects an NF Service instance. If possible, the SCP interacts with NRF to get selection parameters such as location, capacity, etc. The SCP routes the request to the selected NF service producer instance.

Model D—Indirect communication with delegated discovery: Consumers do not do any discovery or selection. The consumer adds any necessary discovery and selection parameters required to find a suitable producer to the service request. The SCP uses the request address and the discovery and selection parameters in the request message to route the request to a suitable producer instance. The SCP can perform discovery with an NRF and obtain a discovery result.

FIG. 8 shows a flowchart of a method according to an embodiment of the present disclosure, which may be performed by an apparatus implemented in or at or as a sender network function (NF) or communicatively coupled to the sender NF. As such, the apparatus may provide means or modules for accomplishing various parts of the method 800 as well as means or modules for accomplishing other processes in conjunction with other components.

In an embodiment, the method 800 may be implemented in Model A—Direct communication without NRF interaction or Model B—Direct communication with NRF interaction or Model C—Indirect communication without delegated discovery as shown in FIG. 7.

At block 802, the sender NF may send a first message to a receiver NF. The first message comprises an NF instance identifier (ID) of the sender NF and an NF instance ID of the receiver NF. The sender NF may be any suitable network device or node or entity or function. The receiver NF may be any suitable network device or node or entity or function.

In an embodiment, the first message comprises a new Hyper Text Transfer Protocol (HTTP) header which comprises an NF instance identifier (ID) of the sender NF and an NF instance ID of the receiver NF.

In an embodiment, the sender NF is an NF service consumer or an NF service producer, e.g., as shown in FIG. 7.

In an embodiment, the receiver NF is an NF service producer or an NF service consumer, e.g., as shown in FIG. 7.

For example, the sender NF may be an NF service consumer and the receiver NF may be an NF service producer. Alternatively, the sender NF may be an NF service producer and the receiver NF may be an NF service consumer.

In an embodiment, the sender NF is an HTTP client and the receiver NF is an HTTP server.

In an embodiment, the sender NF is an HTTP server and the receiver NF is an HTTP client.

The first message may be any suitable message which is required to be exchanged between the sender NF and the receiver NF.

In an embodiment, the first message is an HTTP message such as HTTP/1.1 (Hypertext Transfer Protocol Version 1.1) message or HTTP/2 (Hypertext Transfer Protocol Version 2) message.

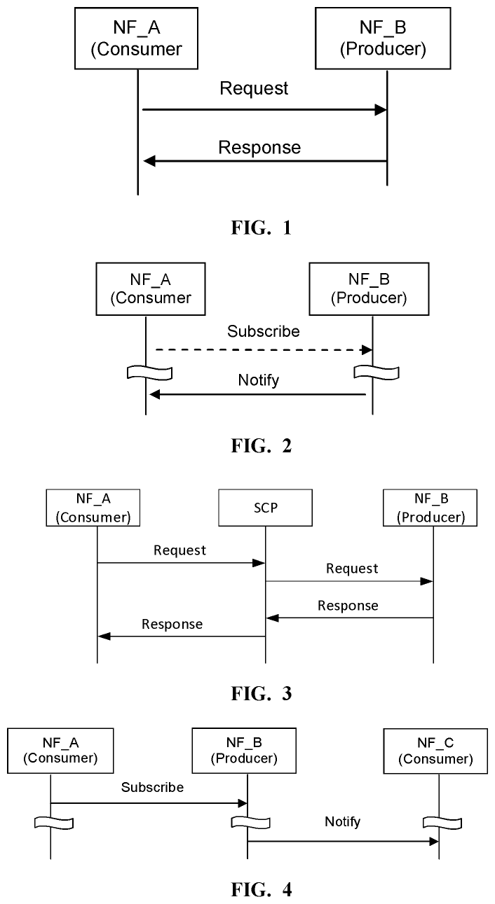

In an embodiment, the first message is a service request message or a notification request message. For example, the first message may be a subscribe request as shown in FIG. 7. The first message may be a request message or a subscribe request message or a notify message as shown in FIGS. 1-5.

The NF instance refers to an identifiable instance of the NF. In an embodiment, the NF instance ID of the sender NF is comprised in a message body or an existing Hyper Text Transfer Protocol (HTTP) header or a new HTTP header or an HTTP/2 frame.

In an embodiment, the NF instance ID of the receiver NF is comprised in a message body or an existing HTTP header or a new HTTP header or an HTTP/2 frame.

As a first example, the NF instance ID of the sender NF may be comprised in a message body. The NF instance ID of the receiver NF may be comprised in a message body or an existing HTTP header or a new HTTP header or an HTTP/2 frame.

As a second example, the NF instance ID of the sender NF may be comprised in an existing HTTP header. The NF instance ID of the receiver NF may be comprised in a message body or an existing HTTP header or a new HTTP header or an HTTP/2 frame.

As a third example, the NF instance ID of the sender NF may be comprised in a new HTTP header. The NF instance ID of the receiver NF may be comprised in a message body or an existing HTTP header or a new HTTP header or an HTTP/2 frame.

As a fourth example, the NF instance ID of the sender NF may be comprised in an HTTP/2 frame. The NF instance ID of the receiver NF may be comprised in a message body or an existing HTTP header or a new HTTP header or an HTTP/2 frame.

In an embodiment, the NF instance ID of the sender NF and the NF instance ID of the receiver NF are used to identify a message exchanged between the sender NF and the receiver NF. For example, an NF between the sender NF and the receiver NF may identify the message exchanged between the sender NF and the receiver NF based on the NF instance ID of the sender NF and the NF instance ID of the receiver NF.

In an embodiment, the first message further comprises an NF service instance ID of the sender NF and an NF service instance ID of the receiver NF. The NF service instance refers to an identifiable instance of the NF service.

In an embodiment, the NF service instance ID of the sender NF is comprised in a message body or an existing HTTP header or a new HTTP header or an HTTP/2 frame.

In an embodiment, the NF service instance ID of the receiver NF is comprised in a message body or an existing HTTP header or a new HTTP header or an HTTP/2 frame.

As a first example, the NF service instance ID of the sender NF may be comprised in a message body. The NF service instance ID of the receiver NF may be comprised in a message body or an existing HTTP header or a new HTTP header or an HTTP/2 frame.

As a second example, the NF service instance ID of the sender NF may be comprised in an existing HTTP header. The NF service instance ID of the receiver NF may be comprised in a message body or an existing HTTP header or a new HTTP header or an HTTP/2 frame.

As a third example, the NF service instance ID of the sender NF may be comprised in a new HTTP header. The NF service instance ID of the receiver NF may be comprised in a message body or an existing HTTP header or a new HTTP header or an HTTP/2 frame.

As a fourth example, the NF service instance ID of the sender NF may be comprised in an HTTP/2 frame. The NF service instance ID of the receiver NF may be comprised in a message body or an existing HTTP header or a new HTTP header or an HTTP/2 frame.

In an embodiment, the NF instance ID of the sender NF, the NF instance ID of the receiver NF, the NF service instance ID of the sender NF and the NF service instance ID of the receiver NF are used to identify a message exchanged between the sender NF and the receiver NF. For example, an NF between the sender NF and the receiver NF may identify the message exchanged between the sender NF and the receiver NF based on the NF instance ID of the sender NF, the NF instance ID of the receiver NF, the NF service instance ID of the sender NF and the NF service instance ID of the receiver NF.

FIG. 9 shows a flowchart of a method according to another embodiment of the present disclosure, which may be performed by an apparatus implemented in or at or as a sender network function (NF) or communicatively coupled to the sender NF. As such, the apparatus may provide means or modules for accomplishing various parts of the method 900 as well as means or modules for accomplishing other processes in conjunction with other components. For some parts which have been described in the above embodiments, the description thereof is omitted here for brevity.

In an embodiment, the method 900 may be implemented in Model A—Direct communication without NRF interaction or Model B—Direct communication with NRF interaction or Model C—Indirect communication without delegated discovery as shown in FIG. 7.

At block 902, the sender NF may receive a second message from the receiver NF. The second message comprises the NF instance ID of the sender NF and the NF instance ID of the receiver NF. For example the second message may be a response for the first message. Alternatively, the second message may be any other suitable message.

The second message may be any suitable message which is required to be exchanged between the sender NF and the receiver NF.

In an embodiment, the second message is an HTTP message.

In an embodiment, the second message is a service response message or a notification response message.

In an embodiment, the NF instance ID of the sender NF is comprised in a message body or an existing Hyper Text Transfer Protocol (HTTP) header or a new HTTP header or an HTTP/2 frame.

In an embodiment, the NF instance ID of the receiver NF is comprised in a message body or an existing HTTP header or a new HTTP header or an HTTP/2 frame.

In an embodiment, the NF instance ID of the sender NF and the NF instance ID of the receiver NF are used to identify a message exchanged between the sender NF and the receiver NF.

In an embodiment, the second message further comprises an NF service instance ID of the sender NF and an NF service instance ID of the receiver NF. The NF service instance refers to an identifiable instance of the NF service.

In an embodiment, the NF service instance ID of the sender NF is comprised in a message body or an existing HTTP header or a new HTTP header or an HTTP/2 frame.

In an embodiment, the NF service instance ID of the receiver NF is comprised in a message body or an existing HTTP header or a new HTTP header or an HTTP/2 frame.

In an embodiment, the NF instance ID of the sender NF, the NF instance ID of the receiver NF, the NF service instance ID of the sender NF and the NF service instance ID of the receiver NF are used to identify a message exchanged between the sender NF and the receiver NF.

In an embodiment, the first message and second message further comprise an NF set ID of the sender NF and an NF set ID of the receiver NF. NF Set refers to a group of interchangeable NF instances of the same type, supporting the same services and the same Network Slice(s). The NF instances in the same NF Set may be geographically distributed but have access to the same context data.

In an embodiment, the NF instance ID of the sender NF, the NF instance ID of the receiver NF, the NF service instance ID of the sender NF, the NF service instance ID of the receiver NF, the NF set ID of the sender NF and the NF set ID of the receiver NF are used to identify a message exchanged between the sender NF and the receiver NF.

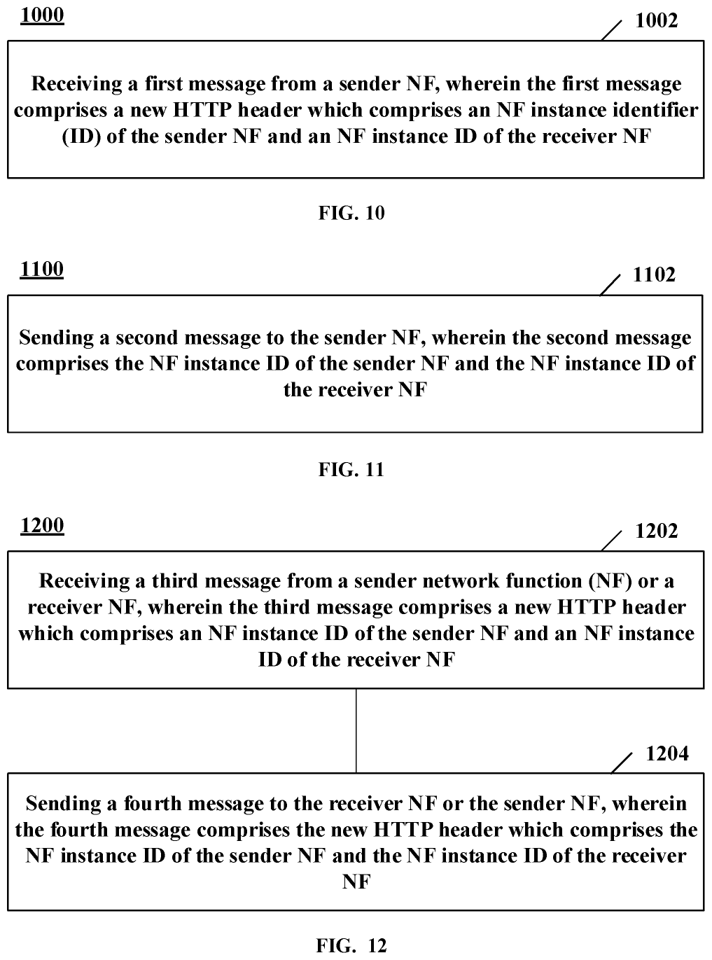

FIG. 10 shows a flowchart of a method according to another embodiment of the present disclosure, which may be performed by an apparatus implemented in or at or as a receiver NF or communicatively coupled to the receiver NF. As such, the apparatus may provide means or modules for accomplishing various parts of the method 1000 as well as means or modules for accomplishing other processes in conjunction with other components. For some parts which have been described in the above embodiments, the description thereof is omitted here for brevity.

In an embodiment, the method 1000 may be implemented in Model A—Direct communication without NRF interaction or Model B—Direct communication with NRF interaction or Model C—Indirect communication without delegated discovery as shown in FIG. 7.

At block 1002, the receiver NF may receive a first message from a sender NF. The first message comprises an NF instance identifier (ID) of the sender NF and an NF instance ID of the receiver NF.

In an embodiment, the first message comprises a new HTTP header which comprises an NF instance identifier (ID) of the sender NF and an NF instance ID of the receiver NF.

For example, the sender NF may send the first message to the receiver NF at block 802 of FIG. 8, and then the receiver NF may receive the first message from the sender NF. Depending on the specific type of the first message, the receiver NF may perform any suitable processing on the first message and the present disclosure has no limit on it.

In an embodiment, the NF instance ID of the sender NF is comprised in a message body or an existing Hyper Text Transfer Protocol (HTTP) header or a new HTTP header or an HTTP/2 frame.

In an embodiment, the NF instance ID of the receiver NF is comprised in a message body or an existing HTTP header or a new HTTP header or an HTTP/2 frame.

In an embodiment, the NF instance ID of the sender NF and the NF instance ID of the receiver NF are used to identify a message exchanged between the sender NF and the receiver NF.

In an embodiment, the first message further comprises an NF service instance ID of the sender NF and an NF service instance ID of the receiver NF.

In an embodiment, the NF service instance ID of the sender NF is comprised in a message body or an existing HTTP header or a new HTTP header or an HTTP/2 frame.

In an embodiment, the NF service instance ID of the receiver NF is comprised in a message body or an existing HTTP header or a new HTTP header or an HTTP/2 frame.

In an embodiment, the NF instance ID of the sender NF, the NF instance ID of the receiver NF, the NF service instance ID of the sender NF and the NF service instance ID of the receiver NF are used to identify a message exchanged between the sender NF and the receiver NF.

In an embodiment, the first message is an HTTP message.

In an embodiment, the first message is a service request message or a notification request message.

FIG. 11 shows a flowchart of a method according to another embodiment of the present disclosure, which may be performed by an apparatus implemented in or at or as a receiver NF or communicatively coupled to the receiver NF. As such, the apparatus may provide means or modules for accomplishing various parts of the method 1100 as well as means or modules for accomplishing other processes in conjunction with other components. For some parts which have been described in the above embodiments, the description thereof is omitted here for brevity.

In an embodiment, the method 1200 may be implemented in Model A—Direct communication without NRF interaction or Model B—Direct communication with NRF interaction or Model C—Indirect communication without delegated discovery as shown in FIG. 7.

At block 1102, the receiver NF may send a second message to the sender NF. The second message comprises the NF instance ID of the sender NF and the NF instance ID of the receiver NF. The second message may be a response for the first message. Alternatively, the second message may be any other suitable message. For example when the receiver NF receives the first message, it may send the second message as a response for the first message to the sender NF and then the sender NF may receive the second message from the receiver NF. Alternatively, the receiver NF may send the second message to the sender NF due to other reasons. For example, the sender NF may be an notification endpoint of a subscription event. The receiver NF may send the second message comprising the subscription event to the sender NF and then the sender NF may receive the second message from the receiver NF. Alternatively, the receiver NF may send the second message as a service request to the sender NF.

The second message may be any suitable message which is required to be exchanged between the sender NF and the receiver NF.

In an embodiment, the second message is an HTTP message.

In an embodiment, the second message is a service response message or a notification response message.

In an embodiment, the NF instance ID of the sender NF is comprised in a message body or an existing Hyper Text Transfer Protocol (HTTP) header or a new HTTP header or an HTTP/2 frame.

In an embodiment, the NF instance ID of the receiver NF is comprised in a message body or an existing HTTP header or a new HTTP header or an HTTP/2 frame.

In an embodiment, the NF instance ID of the sender NF and the NF instance ID of the receiver NF are used to identify a message exchanged between the sender NF and the receiver NF.

In an embodiment, the second message further comprises an NF service instance ID of the sender NF and an NF service instance ID of the receiver NF. The NF service instance refers to an identifiable instance of the NF service.

In an embodiment, the NF service instance ID of the sender NF is comprised in a message body or an existing HTTP header or a new HTTP header or an HTTP/2 frame.

In an embodiment, the NF service instance ID of the receiver NF is comprised in a message body or an existing HTTP header or a new HTTP header or an HTTP/2 frame.

In an embodiment, the NF instance ID of the sender NF, the NF instance ID of the receiver NF, the NF service instance ID of the sender NF and the NF service instance ID of the receiver NF are used to identify a message exchanged between the sender NF and the receiver NF.

In an embodiment, the first message and second message further comprise an NF set ID of the sender NF and an NF set ID of the receiver NF. NF Set refers to a group of interchangeable NF instances of the same type, supporting the same services and the same Network Slice(s). The NF instances in the same NF Set may be geographically distributed but have access to the same context data.

In an embodiment, the NF instance ID of the sender NF, the NF instance ID of the receiver NF, the NF service instance ID of the sender NF, the NF service instance ID of the receiver NF, the NF set ID of the sender NF and the NF set ID of the receiver NF are used to identify a message exchanged between the sender NF and the receiver NF.

FIG. 12 shows a flowchart of a method according to another embodiment of the present disclosure, which may be performed by an apparatus implemented in or at or as an SCP or communicatively coupled to the SCP. As such, the apparatus may provide means or modules for accomplishing various parts of the method 1200 as well as means or modules for accomplishing other processes in conjunction with other components. For some parts which have been described in the above embodiments, the description thereof is omitted here for brevity.

In an embodiment, the method 1200 may be implemented in Model C—Indirect communication without delegated discovery as shown in FIG. 7.

At block 1202, the SCP may receive a third message from a sender NF or a receiver NF. The third message comprises an NF instance ID of the sender NF and an NF instance ID of the receiver NF. For example, the sender may send the first message to the receiver NF via SCP at block 802 of FIG. 8. In this case the third message is the first message. The sender may send the second message from the receiver NF via SCP at block 902 of FIG. 9. In this case the third message is the second message.

In an embodiment, the third message comprises a new HTTP header which comprises an NF instance identifier (ID) of the sender NF and an NF instance ID of the receiver NF.

At block 1204, the SCP may send a fourth message to the receiver NF or the sender NF. The fourth message comprises the NF instance ID of the sender NF and the NF instance ID of the receiver NF. For example, as shown in Model C—Indirect communication without delegated discovery of FIG. 7, when the SCP receives the third message from the sender NF, it may send a fourth message to the receiver NF. When the SCP receive the third message from the receiver NF, it may send a fourth message to the sender NF.

In an embodiment, the fourth message comprises the new HTTP header which comprises an NF instance identifier (ID) of the sender NF and an NF instance ID of the receiver NF.

In an embodiment, the NF instance ID of the sender NF is comprised in a message body or an existing HTTP header or a new HTTP header or an HTTP/2 frame.

In an embodiment, the NF instance ID of the receiver NF is comprised in a message body or an existing HTTP header or a new HTTP header or an HTTP/2 frame.

In an embodiment, the NF instance ID of the sender NF and the NF instance ID of the receiver NF are used to identify a message exchanged between the sender NF and the receiver NF.

In an embodiment, the third message and the fourth message further comprise an NF service instance ID of the sender NF and an NF service instance ID of the receiver NF.

In an embodiment, the NF service instance ID of the sender NF is comprised in a message body or an existing HTTP header or a new HTTP header or an HTTP/2 frame.

In an embodiment, the NF service instance ID of the receiver NF is comprised in a message body or an existing HTTP header or a new HTTP header or an HTTP/2 frame.

In an embodiment, the NF instance ID of the sender NF, the NF instance ID of the receiver NF, the NF service instance ID of the sender NF and the NF service instance ID of the receiver NF are used to identify a message exchanged between the sender NF and the receiver NF.

In an embodiment, the third message and the fourth message are HTTP messages.

In an embodiment, the third message and the fourth message comprise at least one of a service request message, a notification request message, a service response message, or a notification response message.

In an embodiment, the sender NF is an NF service consumer or an NF service producer.

In an embodiment, the receiver NF is NF service consumer or an NF service producer.

In an embodiment, the sender NF is an HTTP client and the receiver NF is an HTTP server.

In an embodiment, the third message and the fourth message further comprise an NF set ID of the sender NF and an NF set ID of the receiver NF.

FIG. 13 shows a flowchart of a method according to another embodiment of the present disclosure, which may be performed by an apparatus implemented in or at or as an sender NF or communicatively coupled to the sender NF. As such. the apparatus may provide means or modules for accomplishing various parts of the method 1300 as well as means or modules for accomplishing other processes in conjunction with other components. For some parts which have been described in the above embodiments, the description thereof is omitted here for brevity.

In an embodiment, the method 1300 may be implemented in Model D—Indirect communication with delegated discovery as shown in FIG. 7.

At block 1302, the sender NF may send a fifth message to a service communication proxy (SCP). The fifth message comprises an NF instance identifier (ID) of the sender NF. For example, as shown in FIG. 7, the consumer (the sender NF) adds any necessary discovery and selection parameters required to find a suitable producer to the service request (e.g., the fifth message). The SCP uses the request address and the discovery and selection parameters in the request message to route the request to a suitable producer instance. The SCP can perform discovery with an NRF and obtain a discovery result.

In an embodiment, the NF instance ID of the sender NF is comprised in a message body or an existing Hyper Text Transfer Protocol (HTTP) header or a new HTTP header or an HTTP/2 frame.

In an embodiment, the fifth message further comprises an NF service instance ID of the sender NF.

In an embodiment, the NF service instance ID of the sender NF is comprised in a message body or an existing HTTP header or a new HTTP header or an HTTP/2 frame.

In an embodiment, the fifth message is an HTTP message.

In an embodiment, the fifth message is a service request message or a notification request message.

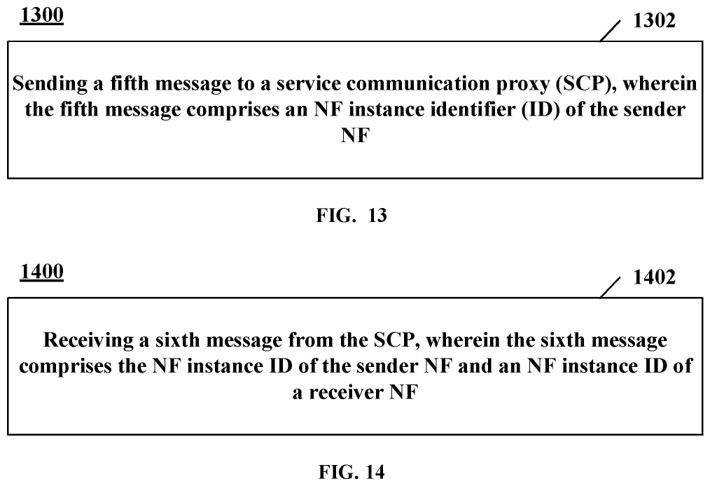

FIG. 14 shows a flowchart of a method according to another embodiment of the present disclosure, which may be performed by an apparatus implemented in or at or as an sender NF or communicatively coupled to the sender NF. As such. the apparatus may provide means or modules for accomplishing various parts of the method 1400 as well as means or modules for accomplishing other processes in conjunction with other components. For some parts which have been described in the above embodiments, the description thereof is omitted here for brevity.

In an embodiment, the method 1400 may be implemented in Model D—Indirect communication with delegated discovery as shown in FIG. 7.

At block 1402, the sender NF may receive a sixth message from the SCP. The sixth message comprises the NF instance ID of the sender NF and an NF instance ID of a receiver NF. For example, as shown in FIG. 7, the SCP may receive a response (e.g., the sixth message) from the receiver NF and send the response to the sender NF.

In an embodiment, the NF instance ID of the receiver NF is comprised in a message body or an existing HTTP header or a new HTTP header or an HTTP/2 frame.

In an embodiment, the NF instance ID of the sender NF and the NF instance ID of the receiver NF are used to identify a message exchanged between the sender NF and the receiver NF.

In an embodiment, the sixth message further comprises the NF service instance ID of the sender NF and the NF service instance ID of the receiver NF.

In an embodiment, the NF service instance ID of the receiver NF is comprised in a message body or an existing HTTP header or a new HTTP header or an HTTP/2 frame.

In an embodiment, the NF instance ID of the sender NF, the NF instance ID of the receiver NF, the NF service instance ID of the sender NF and the NF service instance ID of the receiver NF are used to identify a message exchanged between the sender NF and the receiver NF.

In an embodiment, the fifth message and the sixth message are HTTP messages.

In an embodiment, the sixth message comprise at least one of a service response message, or a notification response message.

In an embodiment, the sender NF is an NF service consumer or an NF service producer.

In an embodiment, the receiver NF is NF service consumer or an NF service producer.

In an embodiment, the sender NF is an HTTP client and the receiver NF is an HTTP server.

In an embodiment, the fifth message and the sixth message further comprise an NF set ID of the sender NF and an NF set ID of the receiver NF.

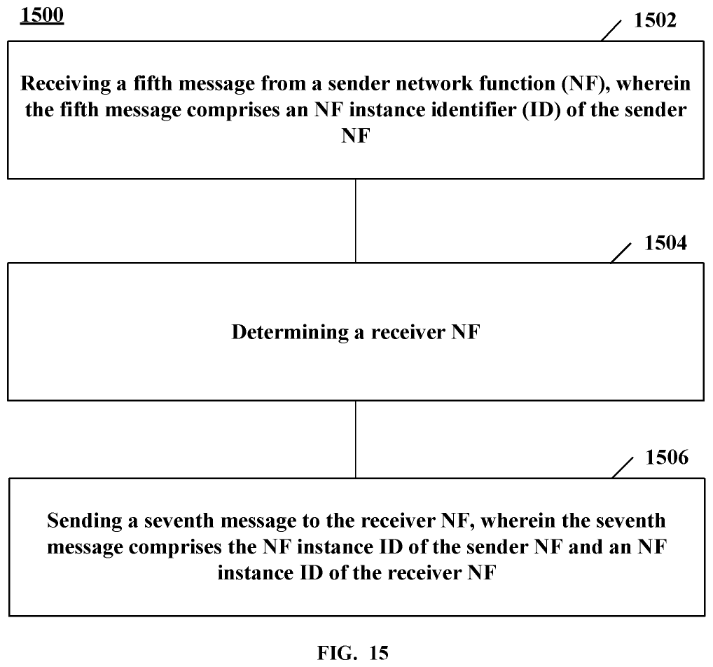

FIG. 15 shows a flowchart of a method according to another embodiment of the present disclosure, which may be performed by an apparatus implemented in or at or as an SCP or communicatively coupled to the SCP. As such, the apparatus may provide means or modules for accomplishing various parts of the method 1500 as well as means or modules for accomplishing other processes in conjunction with other components. For some parts which have been described in the above embodiments, the description thereof is omitted here for brevity.

In an embodiment, the method 1500 may be implemented in Model D—Indirect communication with delegated discovery as shown in FIG. 7.

At block 1502, the SCP may receive a fifth message from a sender network function (NF). The fifth message comprises an NF instance identifier (ID) of the sender NF.

At block 1504, the SCP may determine a receiver NF.

At block 1506, the SCP may send a seventh message to the receiver NF. The seventh message comprises the NF instance ID of the sender NF and an NF instance ID of the receiver NF.

For example, as shown in FIG. 7, the consumer (the sender NF) adds any necessary discovery and selection parameters required to find a suitable producer to the service request (e.g., the fifth message). The SCP uses the request address and the discovery and selection parameters in the request message to route the request to a suitable producer instance. The SCP can perform discovery with an NRF and obtain a discovery result. Then the SCP may send a seventh message to the receiver NF.

In an embodiment, the NF instance ID of the sender NF is comprised in a message body or an existing Hyper Text Transfer Protocol (HTTP) header or a new HTTP header or an HTTP/2 frame.

In an embodiment, the NF instance ID of the receiver NF is comprised in a message body or an existing HTTP header or a new HTTP header or an HTTP/2 frame.

In an embodiment, the NF instance ID of the sender NF and the NF instance ID of the receiver NF are used to identify a message exchanged between the sender NF and the receiver NF.

In an embodiment, the seventh message further comprises an NF service instance ID of the sender NF and an NF service instance ID of the receiver NF.

In an embodiment, the NF service instance ID of the sender NF is comprised in a message body or an existing HTTP header or a new HTTP header or an HTTP/2 frame.

In an embodiment, the NF service instance ID of the receiver NF is comprised in a message body or an existing HTTP header or a new HTTP header or an HTTP/2 frame.

In an embodiment, the NF instance ID of the sender NF, the NF instance ID of the receiver NF, the NF service instance ID of the sender NF and the NF service instance ID of the receiver NF are used to identify a message exchanged between the sender NF and the receiver NF.

In an embodiment, the fifth message and the seventh message are HTTP messages.

In an embodiment, the fifth message and the seventh message comprise at least one of a service request message or a notification request message.

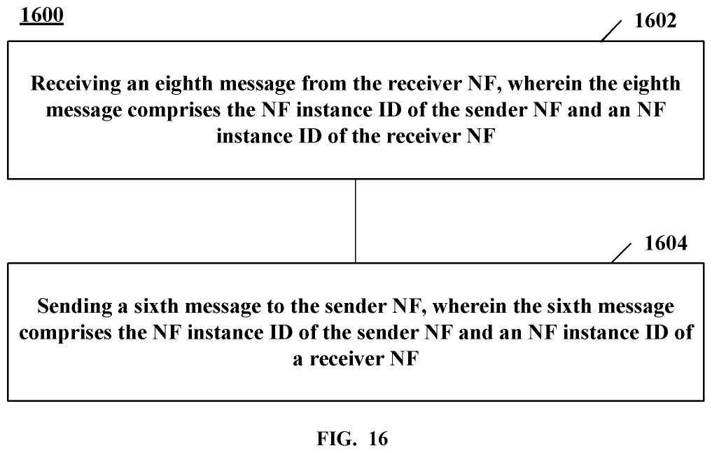

FIG. 16 shows a flowchart of a method according to another embodiment of the present disclosure, which may be performed by an apparatus implemented in or at or as an SCP or communicatively coupled to the SCP. As such, the apparatus may provide means or modules for accomplishing various parts of the method 1600 as well as means or modules for accomplishing other processes in conjunction with other components. For some parts which have been described in the above embodiments, the description thereof is omitted here for brevity.

In an embodiment, the method 1600 may be implemented in Model D—Indirect communication with delegated discovery as shown in FIG. 7.

At block 1602, the SCP may receive an eighth message from the receiver NF. The eighth message comprises the NF instance ID of the sender NF and an NF instance ID of the receiver NF. The eighth message may be a response for the seventh message. Alternatively, the eighth message may be any other suitable message such as a notification request message or a service request. For example when the receiver NF receives the seventh message, it may send the eighth message as a response for the seventh message to the SCP and then the SCP may receive the eighth message from the receiver NF. Alternatively, the receiver NF may send the eighth message to the SCP due to other reasons. For example, the sender NF may be an notification endpoint of a subscription event. The receiver NF may send the eighth message comprising the subscription event to the SCP and then the SCP may receive the eighth message from the receiver NF. Alternatively, the receiver NF may send the eighth message as a service request to the SCP.

At block 1604, the SCP may send a sixth message to the sender NF. The sixth message comprises the NF instance ID of the sender NF and an NF instance ID of a receiver NF.

In an embodiment, the eighth message and the sixth message further comprise the NF service instance ID of the sender NF and the NF service instance ID of the receiver NF.

In an embodiment, the eighth message and the sixth message are HTTP messages.

In an embodiment, the eighth message and the sixth message comprise at least one of a service response message, or a notification response message.

In an embodiment, the sender NF is an NF service consumer or an NF service producer.

In an embodiment, the receiver NF is NF service consumer or an NF service producer.

In an embodiment, the sender NF is an HTTP client and the receiver NF is an HTTP server.

In an embodiment, the fifth message, the sixth message, the seventh message and the eighth message further comprise an NF set ID of the sender NF and an NF set ID of the receiver NF.

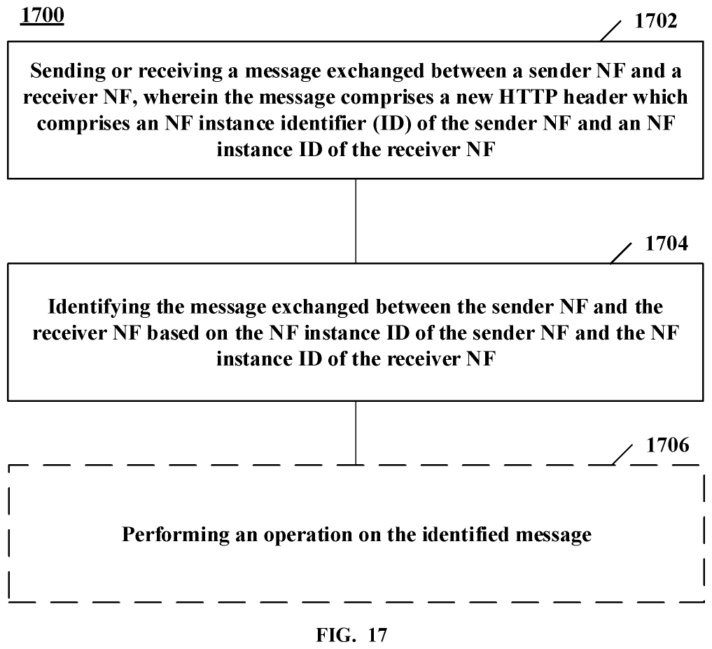

FIG. 17 shows a flowchart of a method according to another embodiment of the present disclosure, which may be performed by an apparatus implemented in or at or as an NE (network entity) or communicatively coupled to the NE. As such, the apparatus may provide means or modules for accomplishing various parts of the method 1700 as well as means or modules for accomplishing other processes in conjunction with other components. For some parts which have been described in the above embodiments, the description thereof is omitted here for brevity. The NE may be any suitable entity. For example, the NE may be entity which requires to perform traffic probing. For example, the NE may be a sender NF or a receiver NF or an entity between the sender NF and the receiver NF.

At block 1702, the NE may send or receive a message exchanged between a sender NF and a receiver NF. The message comprises an NF instance identifier (ID) of the sender NF and an NF instance ID of the receiver NF.

In an embodiment, the message comprises a new HTTP header which comprises an NF instance identifier (ID) of the sender NF and an NF instance ID of the receiver NF.

At block 1704, the NE may identify the message exchanged between the sender NF and the receiver NF based on the NF instance ID of the sender NF and the NF instance ID of the receiver NF.

In an embodiment, the NF instance ID of the sender NF is comprised in a message body or an existing Hyper Text Transfer Protocol (HTTP) header or a new HTTP header or an HTTP/2 frame.

In an embodiment, the NF instance ID of the receiver NF is comprised in a message body or an existing HTTP header or a new HTTP header or an HTTP/2 frame.

In an embodiment, the message further comprises an NF service instance ID of the sender NF and an NF service instance ID of the receiver NF.

In an embodiment, the NF service instance ID of the sender NF is comprised in a message body or an existing HTTP header or a new HTTP header or an HTTP/2 frame.

In an embodiment, the NF service instance ID of the receiver NF is comprised in a message body or an existing HTTP header or a new HTTP header or an HTTP/2 frame.

In an embodiment, the message exchanged between the sender NF and the receiver NF is identified further based on the NF service instance ID of the sender NF and the NF service instance ID of the receiver NF.

In an embodiment, the message is an HTTP message.

In an embodiment, the message is a service request message or a notification request message or a service response message or a notification response message.

In an embodiment, the sender NF is an HTTP client and the receiver NF is an HTTP server.

In an embodiment, the message further comprises an NF set ID of the sender NF and an NF set ID of the receiver NF.

At block 1706, optionally, the NE may perform an operation on the identified message. The operation may be any suitable operation. In an embodiment, the operation comprises at least one of monitoring traffic, filtering traffic, applying policy, troubleshooting, or performance measurement.

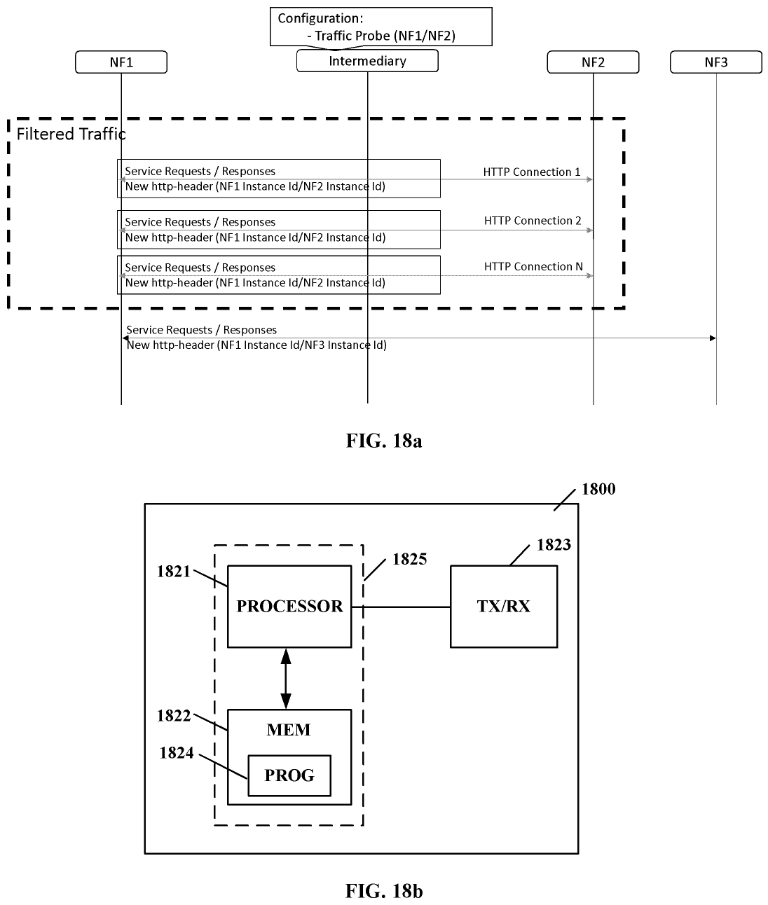

FIG. 18a shows a flowchart of NF interaction mechanisms according to an embodiment of the present disclosure. Network Functions (e.g., NF1, NF2 and NF3) are configured to carry the new HTTP header indicating the sender NF instance ID and receiver NF instance ID in each service request/response. An intermediary (any NF) serving for traffic filtering can be configured to filter the traffic between two certain NFs, e.g., traffic between NF1 and NF2 in the example. According to the information carried in the new HTTP header, the intermediary filters the traffic matching the configuration, e.g., forking the traffic to a configured destination, and discards any unmatching traffic.

In an embodiment, the following information may be added into Table 5.2.3.3-1 of 3GPP TS 29.500 V17.3.0, the disclosure of which is incorporated by reference herein in its entirety.

TABLE 5.2.3.3-1
Optional HTTP custom headers

| Name | Reference | Description |
|---|---|---|
| 3gpp-Sbi-NF-Peer-Info | Clause | This header is used in HTTP request |
| | 5.2.3.3.x | and responses to indicate the sender |
| | | NF and receiver NF of the message. |
| | | The HTTP client may include this |
| | | header in HTTP request when traffic |
| | | probing with peer information is |
| | | required in the network. |
| | | The HTTP server should include the |
| | | received 3gpp-Sbi-NF-Peer-Info |
| | | header in the HTTP response |
| | | message. |
| | | HTTP intermediaries (e.g. SCP) |
| | | should forward this header, when |
| | | relay HTTP messages to next hop. |

In an embodiment, the following information may be added into 3GPP TS 29.500 V17.3.0.

### 5.2.3.3.x 3Gpp-Sbi-NF-Peer-Info

This header contains the IDs of the NF (service) instance as HTTP client and the NF (service) instance as HTTP server.
The encoding of the header follows the ABNF as defined in IETF RFC 7230 [12].
3gpp-Sbi-NF-Peer-Info=“3gpp-Sbi-NF-Peer-Info” “:” OWS “srcinst=” nfInstanceIdvalue [OWS “;” “srcservinst=” nfServiceInstanceIdvalue] OWS “dstcinst=” nfInstanceIdvalue [OWS “;” “dstservinst=” nfServiceInstanceIdvalue]
The following parameters are defined:
srcinst (Source NF instance): indicates the Source NF Instance ID, as defined in 3GPP TS 29.510 [8];
srcservinst (Source NF service instance): indicates the Source NF Service Instance ID, as defined in 3GPP TS 29.510 [8];
dstinst (Destination NF instance): indicates the Destination NF Instance ID, as defined in 3GPP TS 29.510 [8];
dstservinst (Destination NF service instance): indicates the Destination NF Service Instance ID, as defined in 3GPP TS 29.510 [8];
EXAMPLE: 3gpp-Sbi-NF-Peer-Info: srcinst=54804518-4191-46b3-955c-ac631f953ed8; dstinst=54804518-4191-4453-569c-ac631f74765cd

In an embodiment, the following information may be added into 3GPP TS 29.500 V17.3.0.

### 6.13.x SBI Messages Correlation Using NF Peer Information

### 6.13.x.1 General

The procedure enables network analytics tools or probes, to easily identify messages that were exchanged between a specified pair of NF (Service) instances. When supported and configured to be used by operator's policy, an NF as HTTP client or NF as HTTP server may include the NF (Service) instance IDs in 3gpp-Sbi-NF-Peer-Info header, to identify the HTTP requests or responses between the given pair of NF (Service) instances, as further defined in clause 6.13.x.2.

### 6.13.x.2 Principles

An HTTP client originating a request may include in the request the 3gpp-Sbi-NF-Peer-Info header containing the Source NF (Service) instance II) and the Destination NF (Service) instance ID).
Upon receipt of a request that includes the 3gpp-Shi-NF-Peer-Info, the HTTP server, if it supports this header, should include the header in the response sent to the HTTP client, with the same value that was contained in the 3gpp-Sbi-NF-Peer-Info header of the received HTTP request. The HTTP server may include the 3gpp-Sbi-NF-Peer-Info header in a response even when the header is not included in the request received from the HTTP client.
When forwarding a request or response that includes the 3gpp-Sbi-NF-Peer-Info header, the SCP should forward this header unmodified. In an inter-PLMN scenario, the SEPP may remove the header based on operator policies.

According to various embodiments, various messages described above such as the first message, the second message, the third message, the fourth message, the fifth message, the sixth message, the seventh message and/or the eighth message may further compirse any other suitable information (such as NF Service Set ID and/or Service name, etc.) which can be used to identify a message exchanged between a sender NF and a receiver NF.

FIG. 18b is a block diagram showing an apparatus suitable for practicing some embodiments of the disclosure. For example, any one of the sender NF, the receiver NF, the SCP, or the NE described above may be implemented as or through the apparatus 1800.

The apparatus 1800 comprises at least one processor 1821, such as a digital processor (DP), and at least one memory (MEM) 1822 coupled to the processor 1821. The apparatus 1800 may further comprise a transmitter TX and receiver RX 1823 coupled to the processor 1821. The MEM 1822 stores a program (PROG) 1824. The PROG 1824 may include instructions that, when executed on the associated processor 1821, enable the apparatus 1800 to operate in accordance with the embodiments of the present disclosure. A combination of the at least one processor 1821 and the at least one MEM 1822 may form processing means 1825 adapted to implement various embodiments of the present disclosure.

Various embodiments of the present disclosure may be implemented by computer program executable by one or more of the processor 1821, software, firmware, hardware or in a combination thereof.

The MEM 1822 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 1821 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the sender NF, the memory 1822 contains instructions executable by the processor 1821, whereby the sender NF operates according to any of the methods related to the sender NF as described above.

In an embodiment where the apparatus is implemented as or at the receiver NF, the memory 1822 contains instructions executable by the processor 1821, whereby the receiver NF operates according to any of the methods related to the receiver NF as described above.

In an embodiment where the apparatus is implemented as or at the SCP, the memory 1822 contains instructions executable by the processor 1821, whereby the SCP operates according to any of the methods related to the SCP as described above.

In an embodiment where the apparatus is implemented as or at the NE, the memory 1822 contains instructions executable by the processor 1821, whereby the NE operates according to any of the methods related to the NE as described above.

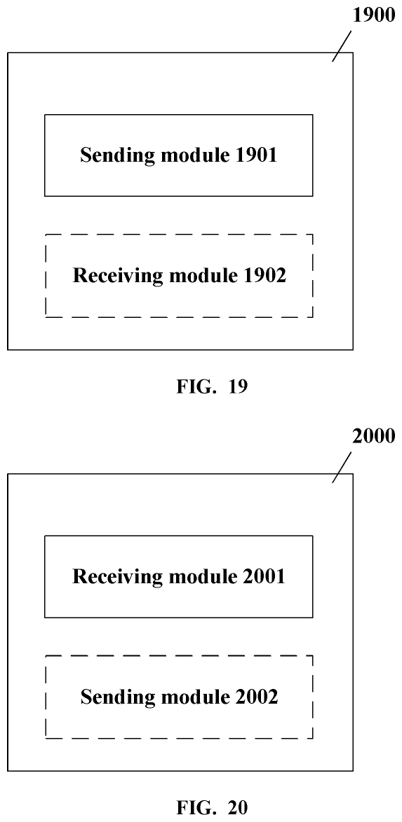

FIG. 19 is a block diagram showing a sender NF according to an embodiment of the disclosure. As shown, the sender NF 1900 comprises a sending module 1901 configured to send a first message to a receiver NF. The first message comprises a new HTTP header which comprises an NF instance identifier (ID) of the sender NF and an NF instance ID of the receiver NF.

In an embodiment, the sender NF 1900 further comprises a receiving module 1902 configured to receive a second message from the receiver NF. The second message comprises the NF instance ID of the sender NF and the NF instance ID of the receiver NF.

FIG. 20 is a block diagram showing a receiver NF according to an embodiment of the disclosure. As shown, the receiver NF 2000 comprises a receiving module 2001 configured to receive a first message from a sender NF. The first message comprises a new HTTP header which comprises an NF instance identifier (ID) of the sender NF and an NF instance ID of the receiver NF.

In an embodiment, the receiver NF 2000 further comprises a sending module 2002 configured to send a second message to the sender NF. The second message comprises the NF instance ID of the sender NF and the NF instance ID of the receiver NF.

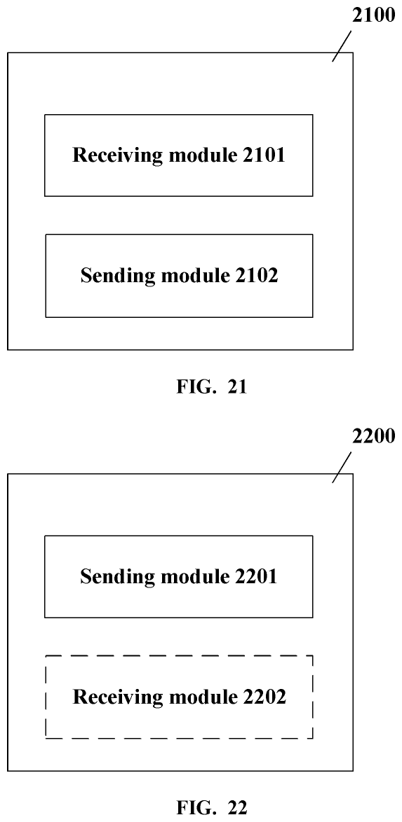

FIG. 21 is a block diagram showing a SCP according to an embodiment of the disclosure. As shown, the SCP 2100 comprises a receiving module 2101 configured to receive a third message from a sender network function (NF) or a receiver NF. The third message comprises a new HTTP header which comprises an NF instance ID of the sender NF and an NF instance ID of the receiver NF. The SCP further comprises a sending module 2102 configured to send a fourth message to the receiver NF or the sender NF, wherein the fourth message comprises a new HTTP header which comprises the NF instance ID of the sender NF and the NF instance ID of the receiver NF.

FIG. 22 is a block diagram showing a sender NF according to another embodiment of the disclosure. As shown, the sender NF 2200 comprises a sending module 2201 configured to send a fifth message to a service communication proxy (SCP). The fifth message comprises an NF instance identifier (ID) of the sender NF.

In an embodiment, the sender NF 2200 further comprises a receiving module 2202 configured to receive a sixth message from the SCP. The sixth message comprises the NF instance ID of the sender NF and an NF instance ID of a receiver NF.

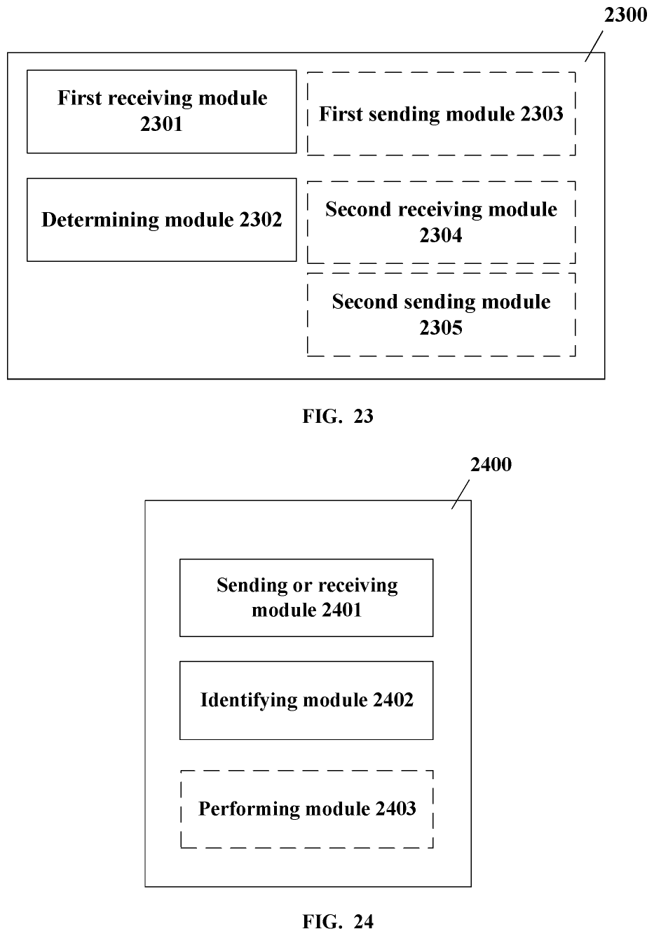

FIG. 23 is a block diagram showing a SCP according to another embodiment of the disclosure. As shown, the SCP 2300 comprises a first receiving module 2301 configured to receive a fifth message from a sender network function (NF). The fifth message comprises an NF instance identifier (ID) of the sender NF. The SCP 2300 further comprises a determining module 2302 configured to determine a receiver NF. The SCP 2300 further comprises a first sending module 2303 configured to send a seventh message to the receiver NF. The seventh message comprises the NF instance ID of the sender NF and an NF instance ID of the receiver NF.

In an embodiment, the SCP 2300 further comprises a second receiving module 2304 configured to receive an eighth message from the receiver NF. The eighth message comprises the NF instance ID of the sender NF and an NF instance ID of the receiver NF.

In an embodiment, the SCP 2300 further comprises a second sending module 2305 configured to send a sixth message to the sender NF. The sixth message comprises the NF instance ID of the sender NF and an NF instance ID of a receiver NF.

FIG. 24 is a block diagram showing an NE according to an embodiment of the disclosure. As shown, the NE 2400 comprises a sending or receiving module 2401 configured to send or receive a message exchanged between a sender NF and a receiver NF. The message comprises a new HTTP header which comprises an NF instance identifier (ID) of the sender NF and an NF instance ID of the receiver NF. The NE 2400 further comprises an identifying module 2402 configured to identify the message exchanged between the sender NF and the receiver NF based on the NF instance ID of the sender NF and the NF instance ID of the receiver NF.

In an embodiment, the NE 2400 further comprises a performing module 2403 configured to perform an operation on the identified message.

Embodiments herein may provide many advantages, of which a non-exhaustive list of examples follows. In some embodiments herein, it is proposed a new mechanism to allow traffic probing between two specified network functions for example in 5GC Service Based Architecture. The embodiments herein are not limited to the features and advantages mentioned above. A person skilled in the art will recognize additional features and advantages upon reading the following detailed description.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the sender NF, the receiver NF, the SCP, or the NE may not need a fixed processor or memory, any computing resource and storage resource may be arranged from the sender NF, the receiver NF, the SCP, or the NE in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method performed by a sender network function (NF), the method comprising:
sending a first message to a receiver NF, the first message comprising a new Hyper Text Transfer Protocol (HTTP) header which comprises an NF instance identifier (ID) of the sender NF and an NF instance ID of the receiver NF.

2. The method according to claim 1, wherein the NF instance ID of the sender NF and the NF instance ID of the receiver NF are used to identify a message exchanged between the sender NF and the receiver NF.

3. The method according to claim 1, wherein the new HTTP header further comprises an NF service instance ID of the sender NF and an NF service instance ID of the receiver NF.

4. The method according to claim 3, wherein the NF instance ID of the sender NF, the NF instance ID of the receiver NF, the NF service instance ID of the sender NF and the NF service instance ID of the receiver NF are used to identify a message exchanged between the sender NF and the receiver NF.

5. The method according to claim 1, wherein the first message is a service request message or a notification request message.

6. The method according to claim 1, further comprising:
receiving a second message from the receiver NF, wherein the second message comprises the NF instance ID of the sender NF and the NF instance ID of the receiver NF.

7. The method according to claim 6, wherein the second message further comprises the NF service instance ID of the sender NF and the NF service instance ID of the receiver NF.

8. The method according to claim 6, wherein the second message is an HTTP message.

9. The method according to claim 6, wherein the second message is a service response message or a notification response message.

10. The method according to claim 1, wherein the sender NF is an NF service consumer or an NF service producer and the receiver NF is an NF service producer or an NF service consumer.

11. The method according to claim 1, wherein the sender NF is an HTTP client and the receiver NF is an HTTP server.

12. The method according to claim 6, wherein the first message and second message further comprises an NF set ID of the sender NF and an NF set ID of the receiver NF.

13.-24. (canceled)

25. A method performed by a service communication proxy (SCP), the method comprising:
receiving a third message from a sender network function (NF) or a receiver NF, the third message comprising a new HTTP header which comprises an NF instance ID of the sender NF and an NF instance ID of the receiver NF; and
sending a fourth message to the receiver NF or the sender NF, the fourth message comprising the new HTTP header which comprises the NF instance ID of the sender NF and the NF instance ID of the receiver NF.

26. The method according to claim 25, wherein the NF instance ID of the sender NF and the NF instance ID of the receiver NF are used to identify a message exchanged between the sender NF and the receiver NF.

27. The method according to claim 25, wherein the new HTTP header further comprises an NF service instance ID of the sender NF and an NF service instance ID of the receiver NF.

28. The method according to claim 27, wherein the NF instance ID of the sender NF, the NF instance ID of the receiver NF, the NF service instance ID of the sender NF and the NF service instance ID of the receiver NF are used to identify a message exchanged between the sender NF and the receiver NF.

29. The method according to claim 25, wherein the third message and the fourth message comprise at least one of:
a service request message;
a notification request message;
a service response message; or
a notification response message.

30. The method according to claim 25, wherein the sender NF is an NF service consumer or an NF service producer and the receiver NF is NF service consumer or an NF service producer.

31. The method according to claim 25, wherein the sender NF is an HTTP client and the receiver NF is an HTTP server.

32. The method according to claim 25, wherein the third message and the fourth message further comprise an NF set ID of the sender NF and an NF set ID of the receiver NF.

33.-41. (canceled)

42. A sender network function (NF), comprising:
a processor; and
a memory coupled to the processor, said the memory containing instructions executable by said the processor, whereby said the sender NF is operative to:
send a first message to a receiver NF, the first message comprising a new Hyper Text Transfer Protocol (HTTP) header which comprising an NF instance identifier (ID) of the sender NF and an NF instance ID of the receiver NF.

43. The sender NF according to claim 42, wherein the NF instance ID of the sender NF and the NF instance ID of the receiver NF are used to identify a message exchanged between the sender NF and the receiver NF.

44. (canceled)

45. (canceled)

46. A service communication proxy (SCP), comprising:
a processor; and
a memory coupled to the processor, said the memory containing instructions executable by said the processor, whereby said the SCP is operative to:
receive a third message from a sender network function (NF) or a receiver NF, the third message comprising a new HTTP header which comprises an NF instance ID of the sender NF and an NF instance ID of the receiver NF; and
send a fourth message to the receiver NF or the sender NF, the fourth message comprising the new HTTP header which comprises the NF instance ID of the sender NF and the NF instance ID of the receiver NF.

47. The SCP according to claim 46, wherein the NF instance ID of the sender NF and the NF instance ID of the receiver NF are used to identify a message exchanged between the sender NF and the receiver NF.

48.-51. (canceled)

52. The sender NF according to claim 42, further operative to:
receive a second message from the receiver NF, wherein the second message comprises the NF instance ID of the sender NF and the NF instance ID of the receiver NF, and wherein the second message is an HTTP message.

53. The sender NF according to claim 42, wherein the sender NF is an HTTP client and the receiver NF is an HTTP server.

54. The SCP according to claim 46, wherein the sender NF is an HTTP client and the receiver NF is an HTTP server.
